(19) United States
(12) Patent Application Publication
(10) Pub. No.: US 2026/0301138 A1
(43) Pub. Date: Oct. 1, 2026

(54) Method and System for Characterizing Microorganisms by Digital Holographic Microscopy

(71) Applicants: BIOMERIEUX, MARCY L'ETOILE (FR); BIOASTER, LYON (FR); UNIVERSITE JEAN MONNET SAINT ETIENNE, SAINT ETIENNE (FR); CENTRE NATIONAL DE LA RECHERCHE SCIENTIFIQUE (CNRS), PARIS (FR)

(72) Inventors: Dylan BRAULT, MONNAIE (FR); Corinne FOURNIER, SAINT ETIENNE (FR); Thomas OLIVIER, SAINT ETIENNE (FR); Nicolas FAURE, GRENOBLE (FR)

(21) Appl. No.: 18/881,863

(22) PCT Filed: Jul. 11, 2023
(86) PCT No.: PCT/EP2023/069245

§ 371 Date: Jan. 7, 2025

(30) Foreign Application Priority Data
Jul. 11, 2022 (EP) 22184039.0
Nov. 24, 2022 (EP) 22209438.5

(51) Int. Cl. G06T 5/80; G03H 1/00; G03H 1/04

(52) U.S. Cl. CPC G06T 5/80; G03H 1/0005; G03H 1/0443; G03H 2001/005; G03H 2001/0452; G03H 2210/55; G03H 2226/02; G06T 2207/10056; G06T 2207/20021

(57) ABSTRACT

The invention relates to a method for characterising microorganisms present in a biological sample, the method comprising acquiring a live holographic digital image of the sample, generating a focused image by using a digital model for reconstructing the focused image and characterising the bacteria on the basis of the focused image. According to the invention, prior to the holographic image being acquired, a plurality of calibration objects are provided in the acquisition field of view, which objects have a previously characterised dimension and refractive index and a shape chosen so that the interference patterns of the objects can be calculated using an image forming model for incorporating optical aberrations of the acquisition device. Prior to the focused image being computer generated, the optical aberrations are qualified according to the interference patterns of the objects and the calculated interference patterns and the digital model for reconstructing the focused image incorporates the quantified optical aberrations.

### TECHNICAL FIELD

The present invention relates to the field of in vitro diagnosis, in particular to the characterization of microorganisms, in particular bacteria, yeasts and fungi, by means of digital in-line holographic microscopy.

The invention is advantageously applicable for determining the Gram of bacteria, for knowing their morphologies or for knowing the metabolic state of microorganisms after applying an antimicrobial agent.

### PRIOR ART

Microorganisms are normally observed in a biological sample by means of color optical microscopy in focus with an incoherent light source of the Kohler type.

However, several problems arise. For example, within the context of in vitro microbial diagnosis, the objects to be imaged in a surface of interest are typically of the order of a micrometer, which requires high magnification microscopic imaging and requires significant expertise equally for preparing the sample, for acquiring the images (selecting the area of interest, focusing), as well as for interpreting the image (recognizing the objects within the context of a complex sample as described above).

Digital holographic microscopy or DHM is an imaging technique that allows the depth-of-field constraints of conventional optical microscopy to be overcome by acquiring defocused images. Schematically, it involves recording an interference pattern, normally called “hologram”, formed by the interference between the light waves diffracted by the observed object and a spatially coherent incident reference wave. DHM microscopy allows computer reconstruction of the phase, which does not allow focused microscopic imaging, as well as the digital reconstruction of an image of the objects observed in various planes parallel to the plane of the image sensor. Furthermore, with the image acquisition being defocused, DHM microscopy dispenses with the need to use a precise, and therefore expensive, plate for moving the optical system and/or the sample along the optical axis.

This technique is described in the review article by Myung K. Kim entitled, “Principles and techniques of digital holographic microscopy”, published in SPIE Reviews Vol. 1, No 1, January 2010, in the article by N. Wu et al., entitled, “Three-dimensional identification of microorganisms using a digital holographic microscope”, published in Computational and Mathematical Methods in Medicine, Vol. 2013, article No ID 162105, in the article by Ahmed El Mallahi entitled, “Automated threedimensional detection and classification of living organisms using digital holography microscopy with partial spatial coherent source: application to monitoring of drinking water resources”, published in Applied Optics, Vol. 52 No 1, January 2013, in European patent application EP 3252455 and French patent application FR 3111998. The article by Soulez, F., Denis, L., Fournier, C., Thiébaut, E. & Goepfert, C., entitled, “Inverse-problem approach for particle digital holography: accurate location based on local optimization”, JOSA A 24, 1164-1171 (2007) and the article by Soulez, F., Denis, L., Thiébaut, É., Fournier, C. & Goepfert, C., entitled, “Inverse problem approach in particle digital holography: out-of-field particle detection made possible”, JOSA A 24, 3708-3716 (2007), for their part describe the 3D reconstruction of the observed objects that resulted in the interference patterns.

While DHNM microscopy, by acquiring defocused images of the microorganisms to be observed and the associated computing reconstruction capabilities, allows simplified use of microscopes, a certain number of problems remain:
due to the nature of the observed sample. In particular, a biological sample derived from Gram staining, spread over a microscope slide observed using DHM, is a dense, heterogeneous, stained complex medium, comprising microscopic objects (for example, bacteria, yeasts, fungi) that often have very low color contrast, that needs to be precisely detected and characterized in order to carry out an in vitro diagnosis;
the images reconstructed by some standard digital methods, such as Rayleigh-Sommerfeld propagation, have artifacts, called twin images, which are the counterpart of the gain in phase information. Other methods, based on approaches referred to as inverse approaches, as described in the aforementioned articles by Soulez, F. et al., do not have these disadvantages but need to be able to make assumptions concerning the structure of the imaged object, for example, its flatness or its regularity.

Irrespective of the considered reconstruction approach, the reconstruction will also be degraded by the optical aberrations of the DHM imaging system, in particular the geometric and colorimetric aberrations. These aberrations add artifacts to the acquired image, which complicates the analysis and the processing of this already complex acquired image. These artifacts are also present within the context of in focus microscopic imaging, but are particularly troublesome within the context of holographic microscopy, since this generally works out of focus, in a domain where the objective lenses are not always optimized, and moreover with variable defocusing, with aberrations that can change from one acquisition to another. Thus, a characterization of the aberrations, a priori on a separate target, as is often carried out in microscopy, risks becoming inoperative on another image.

A correction of the optical aberrations of a DHM system has been proposed in the article by Zheng, G., Ou, X., Horstmeyer, R. & Yang, C., entitled, “Characterization of spatially varying aberrations for wide field-of-view microscopy”, Opt. Express 21, 15131-15143 (2013).

However, this correction is based on an assumption that a reference point exists in the image where there is no aberration, which is a strong and often false assumption, resulting in a relative and non-absolute correction (at the reference point).

### DISCLOSURE OF THE INVENTION

The aim of the invention is to propose a method and a system for characterizing microorganisms using DHM technology correcting the aberrations thereof.

To this end, the aim of the invention is a method for characterizing microorganisms present in a biological sample, comprising:
a. acquiring a defocused digital holographic image by means of a microscopic imaging acquisition device with a coherent or partially coherent light source, said device being configured to form interference patterns on a matrix image sensor between the light source and the light diffracted by the sample;
c. computer generating a focused image by applying a digital model for reconstructing a focused image to the digital holographic image;
d. characterizing the microorganisms as a function of the focused image.

According to the invention:
a. acquiring the digital holographic image includes providing, in the field of view of the acquisition device corresponding to said image, a plurality of calibration objects distinct from the microorganisms present in the biological sample, said objects
   being previously characterized in terms of size and in terms of refractive index;
   having dimensions that are selected so as to produce interference patterns on the matrix image sensor;
   having a shape that is selected such that said interference patterns can be computed using an image formation model integrating optical aberrations of the acquisition device;
b. before computer generating the focused image, the method comprises:
   identifying calibration objects in the digital holographic image;
   computing the interference patterns of the calibration objects by applying the image formation model;
   quantifying the optical aberrations of the acquisition device as a function of the interference patterns of the calibration objects in the holographic image and the computed interference patterns;
c. the digital model for reconstructing the focused image integrates the quantified optical aberrations.

The computation of the aberrations is carried out computationally using a reverse parametric approach using the resolution of a problem according to the following relationships in order to obtain an aberration correction function p(x,y):

$$\underline{{t}^{t}} = arg {min}_{\underline{t}} {‖ d - {m}^{NP} ( \underline{t} ) ‖}_{2}^{2}$$

$${m}^{NP} ( \underline{t} ) = {\vert \underline{t} * {\underline{h}}_{{z}^{6}}^{NP} * p ( x , y ) \vert}^{2}$$

where t^{t} is a refocused image,

$${\underline{h}}_{{z}^{6}}^{NP}$$

is a parametric propagator at the distance z⁶ between the surface of interest (6) and the plane of the sensor (2), like the Lorenz-Mie model, and p(x,y) is the correction function of the aberrations.

In other words, the invention proposes correcting the propagation model, or “propagator”, used for reconstructing the focused image of the aberrations of the system for illuminating and acquiring the image in the interference patterns. As is known per se, the propagators, such as, for example, the best known Lorenz-Mie and Rayleigh-Sommerfeld propagators, are based on significant simplifying assumptions, notably the perfection of the light sources (for example, perfectly coherent source within the context of DHM), a defect-free acquisition system, or even a homogeneous wavefront propagation medium without any jumps in the refractive index. These assumptions are strong assumptions since they result in industrial applications such as DHM microscopy due to the explicit relationships resulting therefrom, which relationships can be handled computationally. Their impact on the reconstruction of the focused image nevertheless can be very significant in terms of the final performance capabilities. Rather than attempting to work on assumptions in order to define new equations for the propagator itself, the invention proposes, by virtue of the addition of calibration objects in the field of view of the DHM acquisition system, computing a correction function that, when it is conjugated to the propagator, to a certain extent reestablishes the reality of the imperfections of the industrial application, whose performance capabilities significantly increase. These objects are used for characterizing aberrations, in particular geometric aberrations. This characterization is carried out by adjusting the data, on certain particular areas of the image, of a “direct” image-forming model integrating the features of the object (in particular the position, the size, the index, and optionally the shape) and those of the optical system (in particular any geometric aberrations). It is thus advantageous to use objects with a relatively simple direct model available, for example, spheres with a homogeneous index (beads), with the Lorenz-Mie model. As will be described hereafter, the use of a direct model allows the scattering of light by the calibration object (for example, a Lorenz-Mie model), its interaction with the incident beam, and aberrations to be combined in a single model. These aberrations, once characterized, are reintroduced into the model for forming the image of the observed microorganisms, which ultimately allows an image (comprising a module and a phase) to be reconstructed in the corrected focus, and therefore allows a more refined reconstruction to be generated that is less affected by artifacts. Once the image is reconstructed in the corrected focus for the estimated aberrations, it can be interpreted either directly by a human operator, or by automatic analysis methods of the machine learning type.

A further aim of the invention is a system for characterizing microorganisms present in a biological sample configured to implement the aforementioned method.

### BRIEF DESCRIPTION OF THE FIGURES

The invention will be better understood upon reading the following description, which is provided solely by way of an example and with reference to the appended drawings, in which:

FIG. 1 is a schematic section view of a digital holographic microscopy acquisition system;

FIG. 2 is a schematic section view of a Gram slide observed by the system of FIG. 1 in an oil immersed configuration;

FIG. 3 is a flowchart of a method according to the invention applied to the detection of the Gram of microorganisms present in a biological sample;

FIG. 4 illustrates the impact of aberrations on the interference patterns produced by the system of FIG. 1;

FIG. 5 illustrates amplitude (left-hand column) and phase (right-hand column) reconstructed without correction of aberrations (top line) and with correction of aberrations (bottom line);

FIG. 6 illustrates a focused reconstructed phase image without correction of aberrations (left-hand image) and with correction of aberrations (right-hand image).

### DETAILED DESCRIPTION OF THE INVENTION

A method and a system according to the invention, applied to determining the Gram of bacteria present in a biological sample taken from a patient, will now be described.

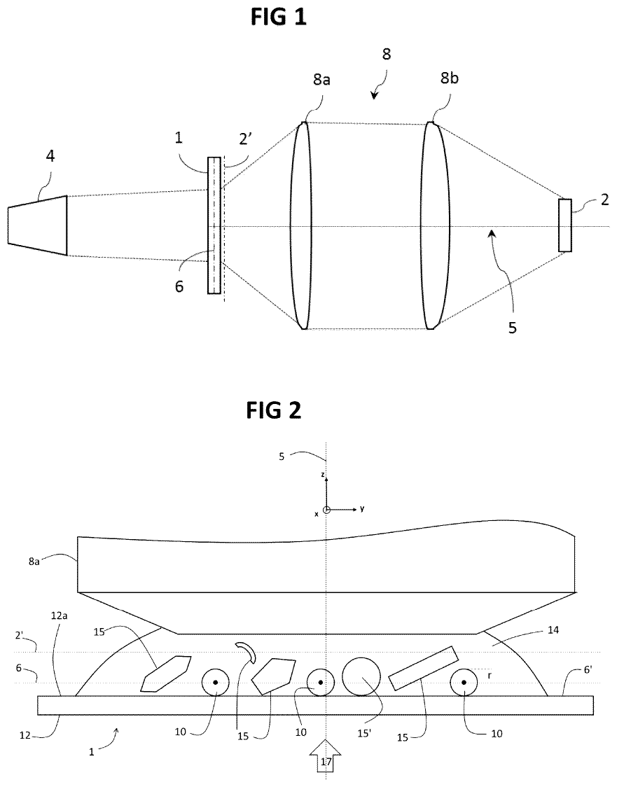

FIG. 1 schematically shows an imaging system, which in this case is an in-line holographic imaging system for imaging a sample 1 by means of a digital image sensor 2, which is placed in an image plane of the holographic imaging system. The imaging system is referred to as a holographic imaging system in that it is capable of acquiring holographic images, but this same imaging system could also acquire non-holographic images. An optical axis 5, referred to as the z-axis, connects the sample 1 and the image sensor 2. This optical axis 5 in this case is shown as being straight, but could be more complex, depending on the configurations. A light source 4 is configured to illuminate the sample 1 in the field of view of the holographic imaging system, by means of an illumination light beam that is coherent enough to acquire a hologram, i.e., coherent or partially coherent. The illumination light has the conventional features required for holographic imaging, without particular additional constraints. The illumination light thus can be monochromatic (for example, with a wavelength of around 637.2 nm) or possibly can be made up of a plurality of wavelengths, which are used one after the other, for example. The imaging system can comprise a set of optical components 8 on the light path between the sample 1 and the image sensor 2. In the illustrated example, the holographic imaging system is provided with a microscope objective lens 8a and a tube lens 8b, disposed between the sample 1 and the digital image sensor 2. However, an optical component like the microscope objective lens 8a is optional, with the invention not being limited to holographic microscopy with a lens or to a particular set of optical components. Of course, the arrangement described herein is a non-limiting example. Any holographic imaging system can be used, whether or not it is in-line, with or without a microscope objective lens, etc. Indeed, the method relies on the exploitation of a holographic image acquired by an imaging system. Thus, as soon as an imaging system can acquire a holographic image in which the interference patterns appear, this imaging system is suitable for implementing the method. The imaging system also comprises an automated data processing system, not shown, comprising at least one processor, a memory, and which is configured to receive at least one holographic image from the image sensor 2 and to process this holographic image according to a method according to the invention. Notably, the computerized system, for example, a personal computer, comprises a permanent computer memory that stores the set of computer-readable instructions for implementing the computation steps described hereinafter.

With reference to FIG. 2, the sample 1 comprises the surface of interest 6 to be imaged. The surface of interest 6 can be flat in the simplest case, or can be curved. The surface of interest 6 can extend in a plane perpendicular to the optical axis 5, or can even have an incline (often referred to as “tilt”) relative to a plane perpendicular to the optical axis 5. The position of the surface of interest 6 denotes the spatial arrangement of the surface of interest 6, including its location and its possible tilt, in the imaging system. The surface of interest 6 can be a portion of the sample 1, particularly when the sample 1 is a three-dimensional object with a certain volume containing several surfaces or layers at several positions on the optical axis 5. More generally, the surface of interest 6 corresponds to the location of the portion of the sample 1 to be imaged. Generally, the sample 1 rests on a support 12, such as, for example, a microscope slide, and the surface of interest 6 advantageously can correspond to the interface 12a between the support 12 and the sample 1, or even to a surface parallel to this interface 12a, as in the illustrated example, or at least whose position can be deduced from the position of the interface 12a between the support 12 and the sample 1. It should be noted that the selection of the surface of interest 6 can benefit from some kind of a priori knowledge concerning the sample 1 and what is to be observed therein, such as, for example, the size of microorganisms 15, in particular bacteria 15′, that are present in the sample 1 and are likely to rest on the support 12. By convention, an (O, x, y, z) coordinate system is defined with the intersection of the optical axis 5 and the surface of interest 6 as the origin, for orthogonal axes (x,y) in said surface 6 and where the z-axis is equal to the optical axis 5 and is oriented toward the sensor 2.

The sample 1 includes at least one calibration object 10 that is located at a position corresponding to the position of the surface of interest 6. A calibration object 10 assumes a known shape that can be described by geometric parameters and a refractive index. Preferably, the sample 1 comprises a plurality of calibration objects 10, at least 3 reference objects 10, and more preferably at least 5 calibration objects 10. If it is possible for the sample 1 to contain multiple calibration objects 10, it is generally not necessary to have more than 100 calibration objects 10 appearing in an acquired image. More specifically, the number of calibration objects depends on the desired spatial precision for mapping aberrations.

The characterizing parameters associated with the calibration objects 10 include at least position parameters individually locating each of the calibration objects 10, typically position coordinates. The “position of a reference object 10” is understood to mean the spatial arrangement of said reference object 10, including its location and its possible tilt, in the imaging system. Preferably, the characterizing parameters associated with the calibration objects 10 also include geometric parameters describing the known shape of the calibration objects 10. The geometric parameters correspond to a priori knowledge of the geometric shape of the calibration objects 10. In this regard, the calibration objects 10 have a simple geometric shape, and preferably, a calibration object 10 has a spherical, cylindrical or ellipsoidal shape so as to be able to use “parametric” 3D reconstruction approaches, as will be described hereafter. In the case of a calibration object 10 with a spherical shape, the geometric parameters simply can be formed by the radius r of a sphere modeling the calibration object 10, with the position coordinates then corresponding to the position of the center of this sphere. More generally, the parameters are those taken into account by the light diffraction model that will be used (for example, the Mie model, the generalized Mie model, the Thompson model or the Rayleigh model). Thus, for a generally spherical calibration object 10, the Mie light diffraction model (or Lorenz-Mie solution) only requires the radius of the sphere as a geometric parameter. In the case of a calibration object 10 with a generally cylindrical shape, a radius and a length are the only geometric parameters needed to describe the shape. Consequently, all the geometric parameters of the calibration objects 10 do not have to be known, but only those corresponding to an approximation of the shape of the calibration objects 10 and that are used by the light diffraction mode.

The size of the calibration object 10 can be selected from a wide range, and can have a diameter (largest dimension) ranging from 10 nm to 100 μm, for example. The selection of the size of the calibration object 10 is more conditioned by secondary aspects. On the one hand, the size of the calibration object 10 must allow a sufficient contrast to be generated, taking into account the wavelength of the illumination light, the difference in index with the medium around the calibration object 10, or even the contrast generated by other objects in the holographic image. The diameter of the calibration object 10 is thus preferably greater than 10 nm, and more preferably greater than 100 nm. On the other hand, the projected surface of the calibration objects 10 on the image sensor 2 must not be too great so as not to alter the quality of the holographic image. Typically, a projected surface of less than 10% (and more preferably less than 1%) will allow good holographic image quality to be provided, if, in addition, the rest of the sample 1 is not too dense. Furthermore, the calibration objects 10 must not hide the rest of the sample 1, and notably the surface of interest 6. The size of the calibration objects 10 is therefore selected so as not to occupy too much space in the field of view of the image sensor 2. In this regard, the calibration objects 10 are preferably remote from one another, and are not adjacent, and are preferably sparsely distributed over the entire field of view of the image sensor 2.

A calibration object 10 has, like any material, a refractive index. Insofar as the calibration object 10 is distinct from the rest of the sample 1, its refractive index differs from the medium that surrounds it, even if only very slightly. Thus, a refractive index of a calibration object 10 that differs by 0.01 from the refractive index of the medium surrounding the calibration object 10 allows its impact to be identified on the light diffraction in an acquired image, and therefore allows the method to be implemented. Preferably, however, the refractive index of the reference object 10 differs by at least 0.05 relative to the refractive index of the portion of the sample 1 that is immediately adjacent to the calibration object 10, and more preferably by at least 0.1. The refractive index of the calibration object 10 is preferably known and entered into the light diffraction model. In particular, in the case whereby the calibration object 10 is opaque, i.e., the complex component of its refractive index can be considered to be tending toward infinity at the considered wavelength, the light diffraction model can be modified accordingly in order to limit the number of parameters to be adjusted in order to reduce the computation time, and to avoid any overadjustment. In the case of a transparent or partially transparent calibration object 10, the refractive index of the calibration object 10 also may be unknown, or imprecisely known, and may be estimated in the same way as the geometric or position parameters associated with the calibration object 10, via the use of the diffraction model, and thus form part of the characterizing parameters associated with the calibration object 10.

With reference to FIG. 2, the sample 1 can include an immersion medium 14, notably glycerol when the acquisition system 8 includes an immersion microscope and the light diffraction pattern can involve a refractive index of said immersion medium 14.

Apart from the fact that the calibration object 10 must have a known shape that is described by characterizing parameters associated therewith, or even must be very small relative to the wavelength of the illumination light, there are limited constraints concerning the selection of a calibration object 10. A reference object 10 can be opaque or transparent, and can be formed by various materials, such as, for example, silica, polystyrene, or a metal, such as gold. In light of the above considerations, a calibration object 10 can be an artificial object added to the sample 1. The advantage of adding an artificial calibration object mainly lies in the precise knowledge of its geometric parameters and of its refractive index, as well as in the regularity of its shape. In the case of artificial calibration objects 10 added to the sample 1, these are selected so as to have a simple and regular, preferably cylindrical or ellipsoidal, shape, and more preferably a spherical shape, in order to allow the best match between the actual shape of the calibration object 10 and its approximation described by the characterizing parameters taken into account by the diffraction model. For example, in the case illustrated in FIG. 2, the calibration objects 10 are opaque polystyrene beads with a diameter of 1 μm.

The calibration object 10 also can be present on the support 12 of the sample 1, forming part of the support 12 at its interface with the sample 1. For example, it is possible to etch, for example, by photolithography, the surface 12a of the support 12 in order to reveal shapes therein, preferably round shapes, that can meet the requirements of a calibration object (round ribs, for example).

As mentioned above, the calibration object 10 is located at a position matching the position of the surface of interest 6, i.e., a matching relationship exists between the position of the surface of interest 6 and the position of each calibration object 10. For example, the density of the objects 10 is selected so that they are deposited onto the support 12. The surface of interest 6 to be imaged is then defined by the plane passing through the centers of the objects 10 when these objects are calibrated beads. It should be noted that it is also possible to implement the invention for calibration objects suspended in the medium 14.

If some configurations do not pose any problem, such as, for example, when the surface of interest 6 coincides with a surface of the support 12 on which calibration objects 10 are formed, other configurations can sometimes require taking precautions in order to ensure a match between the position of a calibration object 10 and the surface of interest 6. When the surface of interest 6 coincides with the surface 12a of the support 12, or is linked to this surface 12a of the support 12, for example, by a parallelism relationship, it is possible to deposit the calibration objects 10 directly onto the surface 12a of the support 12 before the rest of the sample 1 is installed on the support 12. Thus, a fluid immersion medium 14 (for example, water) containing the suspended calibration objects 10 can be previously deposited onto the surface 12a of the support 12 before the rest of the sample 1 is installed.

Once the sample 1 has been installed, the sample 1 is illuminated 17, and the image sensor 2 acquires at least one two-dimensional holographic image. It can be an image that is acquired in an isolated manner, or a series of images, and in particular a series of holographic images acquired for various positions of the acquisition plane 2′ relative to the sample 1 along the optical axis 5 and/or with different wavelengths for the illumination light.

These various positions of the acquisition plane 2′ relative to the sample 1 can be obtained by various positions of the sample 1 along the optical axis 5 relative to the image sensor 2, for example, by moving the image sensor 2, for example, via a motorized rail or a motorized plate.

In the same way as any type of holographic imaging system can be used as mentioned above, various holographic image acquisition techniques can be used, as long as the acquired image reveals the optical effects of the presence of the reference objects 10 in the field of view of the digital image sensor 2, and in particular the interference patterns generated by the interference between the illumination light and the light scattered by the reference objects 10, appearing in the holographic image as interference patterns caused by the reference object. Needless to say, however, the image is acquired with the holographic imaging system in a configuration that is suitable for imaging the calibration objects 10 (or rather the interference patterns caused by them), and therefore with the appropriate adjustments (illumination, etc.) that are common for a person skilled in the art.

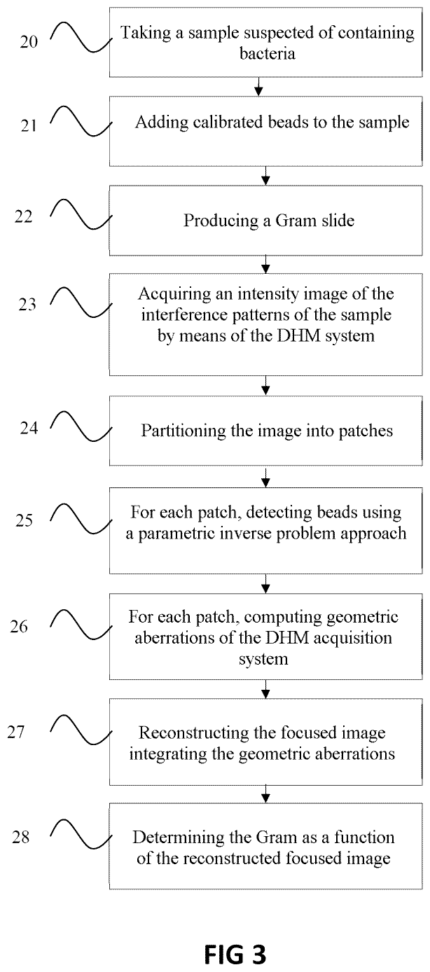

An example of the method according to the invention applied to determining the Gram of microorganisms, in particular bacteria, present in a biological sample will now be described with reference to FIG. 3.

The method for determining the Gram of bacteria begins, in step 20, by sampling a biological sample suspected of containing microorganisms, notably bacteria, yeasts or fungi. The sample can be any type of sample, for example, a sample taken from a patient or an animal, a sample taken from a cosmetic product or a food product, or an environmental sample (water, soil, air, etc.).

Then, in step 21, beads are added to this sample in liquid form that act as calibration objects for correcting any geometric aberrations impacting the formation of the interference patterns acquired by the DHM acquisition system 8. In order to properly undertake this correction, the sample advantageously is a stable colloidal suspension in order to avoid the aggregation of the beads before depositing the biological sample onto a microscope slide. Advantageously:
i. The size and the refractive index of the beads are also selected so as to have a limited variation, preferably less than 50%. As will be described hereafter, this limitation allows effective automatic identification of the beads in the acquired DHM images, and therefore allows complete automation of the method according to the invention.
ii. The beads must not be too similar to the objects expected in the sample in order to limit the risk of confusing them with these objects. In particular, in the case that often occurs in microbiology whereby quasi-spherical biological objects with a comparable size to the bead could be present (for example, shells), the indices of the beads and that of the microorganisms are sufficiently different, which can be achieved, for example, through the choice of material for the beads (for example, a metal), or through staining of the microorganisms (complex component of the non-zero refractive index in certain wavelengths).
iii. The bead is large enough to sufficiently scatter the incident light (according to Rayleigh's law, very small particles do not scatter much light, according to an 1/r\hat{ }4 law) in order to form an interference pattern that is sufficiently contrasted on the plane of the sensor 2. Moreover, it must be small enough to allow scattering over a wide enough angle (according to the Mie law), and to avoid occupying too much of the field. In practice, a bead from a few tens of nm to a few tens of m is suitable, with a preference of a few hundred nm to a few m in the area.
iv. The surface concentration of beads deposited onto the microscope slide stems from the deposited volume, the initial concentration of beads and their possible state of aggregation, and is carefully selected. If the surface concentration of beads is too low after deposition, there is a risk of not having any in the field, or not enough to produce a correct map. Conversely, if the surface concentration of beads is too high, they will scatter the incident light too much, reduce the signal-to-noise ratio of the objects of interest and introduce artifacts into the reconstruction. In practice, 3 to 300 beads on average per field is an operating area, with a preference for 5 to 30, as described hereafter.
v. The shape of the calibrating object must allow the implementation of a direct light scattering model. As a bead is spherical, then this involves the relatively simple case where the Lorenz-Mie model applies, but, if necessary, other scattering models exist for more complex objects, as described, for example, in the article by Gouesbet, G. & Mees, L., entitled, “Generalized Lorenz-Mie theory for infinitely long elliptical cylinders”, JOSAA 16, 1333-1341 (1999).

The method continues, in step 22, by producing a Gram slide in a manner known per se. Once the sample has been dried, glycerol is added to the microscope slide, the microscope is immersed in glycerol and one or more DHM images is/are acquired in step 23.

The acquired DHM image is then advantageously cut, in step 24, into several sub-images, or “patches”, in order to obtain a correction of the aberrations of the acquisition system 8 that is variable in the field of view thereof.

The method continues, in step 25, through an approximate characterization of the positions and geometric features and indices of the beads 10 in each patch by reconstructing the focused image of the beads 10 using a non-aberration corrected propagator. The main aim of this optional step is to approximately characterize the search space described hereafter, notably to identify the areas in which the desired local optima are located in order to accelerate the computation time. This step thus allows the method according to the invention to be implemented in (quasi) real time and/or the use of limited computing resources. If the method according to the invention uses significant computing resources, such as, for example, a network architecture made up of a sufficient number of computing nodes for the targeted computation time, apriori assumptions concerning the search space can be determined and step 25 can be omitted.

Step 25 is advantageously based on a parametric approach for reconstructing beads that is achievable by the selection of the geometry of the calibration objects. The reconstruction uses a Lorenz-Mie propagator, for example, that described in the article by Slimani, Farid et al., entitled, “Near-field Lorenz-Mie theory and its application to microholography”, Applied Optics (1984). In a first iteration, an optimization problem according to the following relationship is implemented:

$${v}^{t} = arg {min}_{v ∈ D} {‖ d - {m}^{Mie} ( v ) ‖}_{2 , W}^{2} \qquad ( 1 )$$

in which relationship:
v=(x y z r n) characterizes the position (x, y, z) in a coordinate system whose origin is equal to the intersection between the optical axis 5 and the plane of the sensor 2, r is the radius of the beads and n is their refractive index;
m^{Mie}(v) is the Lorenz-Mie model applied to a bead;
d is the intensity image of the considered patch;
∥·∥_{2,W} is the norm of the least squares weighted by the inverse of the noise covariance matrix. This noise can be characterized a priori to improve the performance capabilities of the detection (for example, the noise of the sensor, the dead pixels, etc.). By default, the noise is considered to be uniform and equal to a Gaussian white noise;
D is a search domain advantageously limited to the features of the beads that are calibrated. Notably, the search space is limited in its variables r and n to the space [r₀−Δr; r₀+Δr]×[n₀−Δn; n₀+Δn] where r₀ and n₀ are, respectively, the nominal values of the radius and of the refractive index of the beads, and Δr and Δn are, respectively, their scattering, with this data being provided, for example, by the bead manufacturer. Preferably, the index of the beads, and more generally of the calibration objects, is known with an uncertainty Δn of ±2%. In the first iteration, the spatial search space (x, y, z) is limited to the field of view of the acquisition system corresponding to the considered patch and to an approximate depth z corresponding to the sample 1.

Since the model is translationally invariant in (x,y), solving this problem involves finding a maximum correlation between the model and the data in the plane (x,y), for each subset of parameters (z, r, n). In order to effectively solve the problem according to relationship 1, the LINCOA algorithm described in the document by J. Nocedal and S. Wright, entitled, “Numerical optimization”, Springer Science & Business Media, 2006, is preferred.

On completion of this first iteration, if the residues are below a predetermined threshold, for example, quantified by the least squares norm, then a first bead with features v^{t} is identified at the position (x^{t} y^{t} z^{t}) with a radius r^{t} and an index n^{t}. With the selection of beads having a refractive index different from the objects expected in the biological sample, the optimization problem (1) allows the bead to be identified from among the other objects. On completion of this first iteration, the interference pattern corresponding to the identified bead is subtracted from the patch, then a new optimization problem is implemented according to relationship (1), with the patch eliminated from the interference pattern. This iterative process continues as long as a new bead is detected. Once the process has stopped for this patch, then step 25 is implemented for the following patch until all the patches have been covered. For an approximate detection of the beads, it is also possible to refer to the method described in the article by Soulez, F., Denis, L., Fournier, C., Thiébaut, É. & Goepfert, C., entitled, “Inverse-problem approach for particle digital holography: accurate location based on local optimization”, JOSA A 24, 1164-1171 (2007).

After implementing step 25, a rough evaluation of their position, radius and refractive index parameters is therefore obtained.

The method according to the invention continues, for each patch, by computing 26 the aberrations impacting the interference patterns of the beads.

As is known per se, reconstructing a focused image of the surface of interest 6 involves finding the transmittance function t^{t}(x,y) of this surface corresponding to a local minimum of the following optimization problem:

$$\underline{{t}^{t}} = arg {min}_{\underline{t}} {‖ d - {m}^{NP} ( \underline{t} ) ‖}_{2 , W}^{2} \qquad ( 2 )$$

$${m}^{NP} ( \underline{t} ) = {\vert \underline{t} * {\underline{h}}_{{z}^{6}}^{NP} \vert}^{2} \qquad ( 3 )$$

where * is the convolution and

$${\underline{h}}_{{z}^{6}}^{NP}$$

is a propagator at the distance z⁶ between the surface of interest 6 and the plane of the sensor 2, this propagator is selected as a function of the intended application. As stated above, the propagators of the prior art do not take into account the aberrations, of whatever nature, affecting the interference patterns recorded by the sensor 2.

According to a preferred embodiment, the invention proposes:
1. Modifying the propagator

$${\underline{h}}_{{z}^{6}}^{NP}$$

according to the prior art with a propagator

$${\underline{h}}_{{z}^{6}}^{INV}$$

according to the relationship:

$${\underline{h}}_{{z}^{6}}^{INV} = {\underline{h}}_{{z}^{6}}^{NP} * p ( x , y ) \qquad ( 4 )$$

where p(x,y) is a function quantifying the geometric aberrations in the interference patterns in the plane of the sensor 2, hereafter called “aberration function”.
2. Describing the function p(x,y) in a frequency base selected as a function of the DHM acquisition system, such that:

$${F}_{{K}_{x} , {K}_{y}} ( p ( x , y ) ) = P ( {K}_{x} , {K}_{y} , α ) = {e}^{i ( {\sum }_{i} {α}_{i} \times {b}_{i} ( {K}_{x} , {K}_{y} ) )} \qquad ( 5 )$$

Where F_{K}_{ₓ}_{,K}_{_{y}} is the Fourier transform, Kₓ and K_{y} are the frequency coordinates in the Fourier domain, b={(bᵢ(Kₓ, K_{y})}ᵢ are the elements of the frequency base α={αᵢ}ᵢ are the coordinates of the function F_{K}_{ₓ}_{,K}_{_{y}}(p(x,y)) in the base b. Advantageously, as will be described hereafter, the base b is that of Zernike polynomials

$${Z}_{n}^{m}$$

(Kₓ,K_{y}), which are particularly well suited for capturing, in the frequency domain, the geometric aberrations of the invariant optical systems as a first approximation around the optical axis. Such polynomials are described, for example, in the article by Zheng, G., Ou, X., Horstmeyer, R. & Yang, C., entitled, “Characterization of spatially varying aberrations for wide field-of-view microscopy”, Opt. Express 21, 15131-15143 (2013). Other polynomials are possible, for example, Legendre polynomials.
3. Computing the coordinates {αᵢ}, of the function F_{K}_{ₓ}_{,K}_{_{y}}(p(x,y)) together with the vector v=(x y z r n) of the calibration beads using a parametric propagator

$${\underline{h}}_{{z}^{6}}^{NP} ,$$

the main advantage of which is to provide a search in the space of solutions that converges without having to regularize the optimization problem, for example, Legendre polynomials or the Lorenz-Mie propagator applied to the beads. Notably, a holographic image formation model is adjusted (for example, the Lorenz-Mie model), convoluted with the aberrations model p(x,y), relative to the data for each bead, with the parameters to be adjusted being the parameters (x y z r n), as well as the {αᵢ}ᵢ.

More specifically, step 26 implements, for each patch and for each bead detected in the patch, the optimization problem according to the relationships:

$$\{ {v}^{t} , {α}^{t} \} = a r g {min}_{v ∈ D , α ∈ C} {‖ d - \underline{m} ( v , α ) ‖}_{2 , W}^{2} \qquad ( 6 )$$

$$m ( v , α ) = {\vert {F}_{x , y}^{- 1} ( p ( {K}_{x} , {K}_{y} , α ) ⊙ {F}_{{K}_{x} , {K}_{y}} ( {m}^{Mie} ( v ) ) ) \vert}^{2} \qquad ( 7 )$$

$$p ( {K}_{x} , {K}_{y} , α ) = {e}^{i ( {\sum }_{n , m} ( {a}_{n}^{m} \times {z}_{n}^{m} ( {K}_{x} , {K}_{y} ) ) )} \qquad ( 8 )$$

$${Z}_{n}^{m} ( {K}_{x} , {K}_{y} ) = \{ \begin{matrix}\sqrt{\frac{2 ( n + 1 )}{1 + {δ}_{m , 0}}} {R}_{n}^{\vert m \vert} ( ρ ) sin ( m ϕ ) & sim > 0 \\ - \sqrt{2 ( n + 1 )} {R}_{n}^{\vert m \vert} ( ρ ) cos ( m ϕ ) & otherwise\end{matrix} \qquad ( 9 )$$

$$ρ = \frac{λ}{NA} \sqrt{{K}_{x}^{2} + {K}_{x}^{2}}$$

$$ϕ = arctan ( \frac{{K}_{y}}{{K}_{y}} ) \qquad ( 9 )$$

$$n ∈ N and m ∈ Z verifying n \geq \vert m \vert and n - \vert m \vert ∈ 2 N$$

in which relationships:
⊙ is the Hadamard product;
m^{Mie} is the Lorenz-Mie model applied to a bead;
NA is the digital aperture of the acquisition system 8 and λ is the wavelength of the illumination;

$${F}_{x , y}^{- 1}$$

is the inverse Fourier transform;
D is the search space for the vector v=(x y z r n) of the considered bead. This search space is advantageously determined by the results of step 25, for example, v^{t}±Δv^{t} with Δv^{t}/v^{t}<0,1. Preferably, the refractive index of the beads, and more generally of the calibration objects, is known with an uncertainty Δn of ±2%;
C is the search space for the coordinates

$$α = {\{ {α}_{n}^{m} \}}_{n , m}$$

in the Zernike polynomials base

$${Z}_{n}^{m} .$$

Studies carried out by the inventors show that, for a DHM acquisition system as described in FIG. 1, the coefficients

$${α}_{n}^{m}$$

range between −10 and 10, with C preferably being limited to the corresponding hypercube.

The inventors have observed that the function P(Kₓ, K_{y}, α) is precisely determined by the first 15 Zernike polynomials, with the vector

$$α = {\{ {α}_{n}^{m} \}}_{n , m}$$

therefore being limited thereto. The coefficient

$${α}_{0}^{0}$$

also can be set to 0 because the model is phase translation-invariant. Moreover, the coefficients

$${α}_{1}^{- 1} {α}_{1}^{1}$$

also can be set to 0 in order to maintain the point spread function (or PSF), which function describes the response of the optical system 8 to a laterally centered point source. The following optimization problem thus comprises 12 adjustable parameters for the aberration model taking into account various geometric aberrations: oblique astigmatism, horizontal and vertical coma, spherical aberrations, and secondary oblique astigmatism. The 5 parameters of the bead scattering model (3 spatial parameters, radius and index) are added to these 12 parameters. Preferably, the problem is solved according to relationships (6-9) by the LINCOA algorithm or other optimization algorithms, such as that described by M. J. D. Powell in, “On fast trust region methods for quadritic models with linear constraints”, Report of the Department of Applied Mathematics and Theoretical Physics, Cambridge University, DAMTP 2014/NA02 (2014).

On completion of step 26, an aberration function p(x,y) is therefore obtained for each position of the interference patterns corresponding to the calibration beads. In a first variant, one function per patch is retained, for example, by averaging the functions p(x,y) in this patch. In a second variant, an overall function p(x,y) for the whole field of view is determined by interpolating the functions p(x,y) computed on all the patches.

The method continues, in step 27, by reconstructing a refocused image based on the DHM image acquired by means of a reconstruction model integrating the modeled geometric aberrations. In terms of determining the Gram of microorganisms, these microorganisms are not known at this stage. They can therefore assume various forms (shells or rods, for example), variable sizes or can even form aggregates or catenaries. In addition, the sample can include various objects (for example, red blood cells). Therefore, an assumption is not made concerning the content of the sample so that a non-parametric propagator is used, for example, a Rayleigh-Sommerfeld propagator

$${\underline{h}}_{z}^{RS}$$

(x,y). The reconstruction of the surface of interest 6 is obtained by solving the problem according to the relationships:

$${\underline{t}}^{t} ( x , y ) = arg {min}_{\underline{t} ( x , y )} ( {D}^{NP} ( \underline{t} ( x , y ) , d ( x , y ) ) + μ {R}^{NP} ( \underline{t} ( x , y , z ) ) ) \qquad ( 10 )$$

$${D}^{NP} ( \underline{t} ( x , y ) , d ( x , y ) ) = {‖ d ( x , y ) - {m}^{NP} ( v , α ) ‖}_{W}^{2} \qquad ( 11 )$$

$${m}^{NP} ( v , α ) = \underline{t} ( x , y ) * {\underline{h}}_{z}^{RS} ( x , y ) * p ( x , y ) \qquad ( 12 )$$

$${\underline{h}}_{z}^{RS} ( x , y ) = \frac{z}{i λ} \frac{exp ( i \frac{2 π}{λ} \sqrt{{x}^{2} + {y}^{2} + {z}^{2}} )}{{x}^{2} + {y}^{2} + {z}^{2}} \qquad ( 13 )$$

in which relationships:
μ is a predetermined scalar or even a problem according to the preceding relationships is solved for each value of a predetermined set of scalars;
R^{NP} (t(x,y)) is a regularization term guaranteeing the convergence of the optimization problem, preferably selected as a function of apriori information concerning the expected reconstructed image, for example, in the case of a usually low contrast Gram slide, the norm L1 of the gradient of the transmittance function t(x,y) or the total variation as described in the article by F. Jolivet et al., entitled, “Regularized reconstruction of absorbing and phase object from a single in-line hologram, application to fluid mechanics and micro-biology”, Opt. Express 26, 2018;
the distance z is set to the average of the distances z computed for the beads in step 26 or even several distances z are selected in order to obtain a stack of focused images and therefore several surfaces of interest 6.

Preferably, the problem is solved according to relationships (10-13) by means of the LINCOA algorithm or the Powell algorithm, for example.

The method continues, in step 28, by analyzing the one or more reconstructed focused images in order to identify the microorganisms that they contain and their Gram. This analysis is carried out in a manner known per se, for example, by a laboratory technician specializing in Gram who analyzes a screen on which the one or more reconstructed focused images is/are displayed, or by using machine-learning automatic characterization computer tools. Determining the Gram then allows the antibiotherapy to be adapted in the case of a patient suspected of being infected with a pathogenic bacterium, or more generally an antimicrobial therapy. Determining the Gram also allows the microbiological analysis workflow to be oriented, such as, for example, the selection of a culture medium for subsequently identifying microorganisms present in the sample, selecting a chart used for producing an antibiogram using the Vitek® 2 platform sold by bioMerieux or even selecting the medium used for producing an identification using the Vitek®MS or Vitek®MS PRIME platform marketed by bioMerieux.

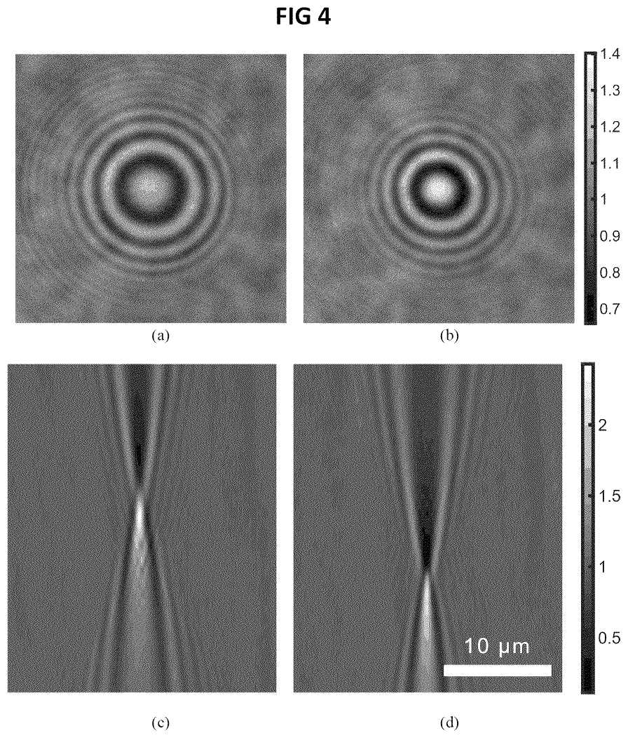

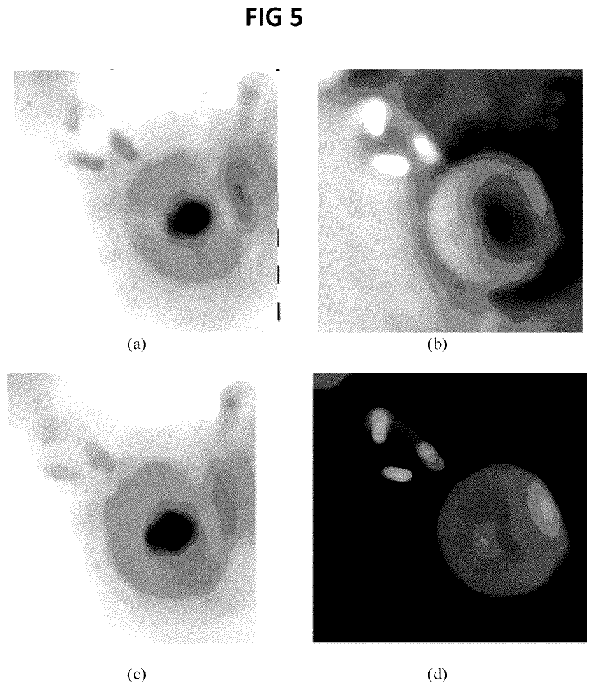

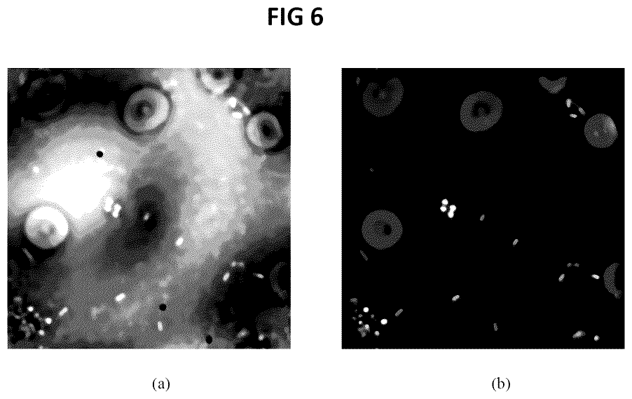

FIG. 4 illustrates the effect of the aberrations introduced by a system as described in FIG. 1. The left-hand column illustrates a system with a contained aberration level and the right-hand column illustrates a system with a significant aberration level. As can be seen, the interference patterns, in this case those associated with a calibration bead, are significantly affected, equally in the plane of the sensor and in their position along the optical axis. FIGS. 5(a) and 5(b) respectively illustrate the reconstructed amplitude and phase of a portion of a Gram slide without correction of the aberrations according to the invention and FIGS. 5(c) and 5(d) illustrate this same portion of a Gram slide with the correction of the aberrations according to the invention applied. FIG. 6 illustrates an overall reconstructed image in focus without correction of the aberrations (FIG. 6(a)) and with correction of the aberrations (FIG. 6(b)).

### Extension of the Teaching of the Detailed Embodiment

An embodiment of the invention has been described that is applied to determining the Gram of microorganisms. The invention applies to any type of characterization of microorganisms using digital in-line holography, for example, determining the sensitivity of microorganisms to an antimicrobial agent, as described in application WO 2017/207184.

More generally, the invention applies to any type of characterization, irrespective of the nature of the sample, whether or not it is biological, as long as the intention is to correct the aberrations impacting the formation of interference patterns acquired by a DHM system.

The use of beads for the calibration has been described. Any type of object capable of undergoing parametric reconstruction by an inverse approach can be suitable: cylinder, ellipsoid, etc.

A direct immersion microscope, without a lamella, and without a correction ring, has been described. A sample covered with a microscope slide with a microscope equipped with a collar for correcting the thickness of said lamella is suitable.

### Extension of the Teaching of the Detailed Embodiment to Several Wavelengths

The use of a single wavelength has been described. Several wavelengths also can be used to characterize a sample.

The simplest way of addressing this problem is to repeat the method for correcting aberrations for each of the wavelengths independently. A function quantifying the aberrations p(x,y) and a transmittance function t^{t}(x,y) are thus obtained for each wavelength λ of a set of wavelengths Λ for which aberration correction is required. These functions will be denoted p_{λ}(x,y) and

$${\underline{t}}_{λ}^{t}$$

(x,y) hereafter for the wavelength λ. An effective correction of the chromatic aberrations is thus obtained.

Beyond this independent processing, and advantageously, correcting chromatic aberrations over several wavelengths can be carried out by benefiting from the physical argument that some features of the objects, in particular the location and the geometry, are invariant with respect to the wavelength. Two methods according to the invention allow this to be achieved, which methods can be used independently or in combination:
1. To begin, one of the wavelengths is set as a reference (denoted λ_{ref} hereafter) and steps 25 and 26 of the method are carried out. The function quantifying the aberrations p_{λ}_{_{ref}}(x,y) is thus obtained, as well as the features of the calibrating objects, in particular their location and their geometric features (for example, their radius r for spherical beads). Then, for each of the other wavelengths, steps 25 to 26 are carried out again, except that (i) the location and geometric parameters are no longer adjustable, and are set so as to be equal to those obtained with λ_{ref}, (ii) the Zernike coefficients

$${α}_{1}^{- 1}$$

and

$${α}_{1}^{1}$$

are now adjustable parameters, not necessarily zero. Thus, consideration is given to the fact that (i) the calibrating objects are assumed to be immovable and geometrically unchanged between two wavelengths, and that (ii), with the system having chromatic aberrations, their image can be translated between one wavelength and another. The chromatic aberrations of the system are thus characterized. Step 27 then can be carried out independently for all the wavelengths, or according to another method such as that described above. Finally, it should be noted that it is possible, by means of a variant of the method, to set more than one wavelength as a reference, which can allow the location and the geometric parameters of the calibrated objects to be more precisely adjusted (for example, through an average between the parameters obtained at the different reference wavelengths).
2. It is expected that the location of the objects in the transmittance plane, once the chromatic aberrations are corrected (for example, independently for each wavelength, or according to the method described in 1.) is invariant between the various wavelengths. Advantageously, this can be reflected in the various problems according to relationships (10)-(13) by defining a regularization term μR^{NP}(t(x,y,z)) shared between the various wavelengths, so as to stipulate an identical location for objects in the transmittance plane for all the wavelengths that are used. A more precise correction of the aberrations is thus obtained. Advantageously, the regularization term common to the various corrections is a term promoting the co-location of the edges of the transmittance functions for the multiple wavelengths according to the relationship:

$${R}^{NP} = {\sum }_{x , y} \sqrt{{\sum }_{λ ε Λ} {∇}_{x , y} {ℜ ( {\underline{t}}_{λ}^{t} ( x , y ) )}^{2} + {∇}_{x , y} {𝔍 ( {\underline{t}}_{λ}^{t} ( x , y ) )}^{2} + {ε}^{2}} \qquad ( 14 )$$

in which relationship:
   Λ is the set of wavelengths used;
   x and y are the coordinates of the pixels in the transmittance functions;
   ∇_{x,y} is the symbol of the gradient;
   [symbol] is the real part of a function;
   [symbol] is the imaginary part of a function;
   ε is a positive scalar with a low value with the purpose of rendering the relationship (14) differentiable and avoiding a zero division in the computation of the derivative of the gradient.

1. A method for characterizing microorganisms present in a biological sample, comprising:
a. acquiring a defocused digital holographic image by means of a microscopic imaging acquisition device with a coherent or partially coherent light source, said device being configured to form interference patterns on a matrix image sensor between the light source and the light diffracted by the sample;
c. computer generating a focused image by applying a digital model for reconstructing a focused image to the defocused digital holographic image;
d. characterizing the microorganisms as a function of the focused image,
characterized in that:
a.1. acquiring the defocused digital holographic image includes providing, in the field of view of the acquisition device corresponding to the defocused digital holographic image, a plurality of calibration objects distinct from the microorganisms present in the biological sample, the calibration objects
being previously characterized in terms of size and in terms of refractive index;
having dimensions that are selected so as to produce interference patterns on the matrix image sensor;
having a shape that is selected such that said interference patterns can be computed using a wavefront propagation model integrating optical aberrations of the acquisition device;
b. before computer generating the focused image, the method comprises:
identifying calibration objects in the defocused digital holographic image;
computing the interference patterns of the calibration objects by applying the wavefront propagation model, and quantifying the optical aberrations of the acquisition device as a function of the interference patterns of the calibration objects in the defocused holographic image and the computed interference patterns;
c.1. the digital model for reconstructing the focused image integrates the quantified optical aberrations,
wherein the computation of the aberrations is carried out computationally using a reverse parametric approach using the resolution of a problem according to the following relationships in order to obtain an aberration correction function p(x,y),
$$\underline{{t}^{t}} = arg {min}_{\underline{t}} {‖ d - {m}^{NP} ( \underline{t} ) ‖}_{2}^{2}$$
$${m}^{NP} ( \underline{t} ) = {\vert \underline{t} * {\underline{h}}_{{z}^{6}}^{NP} * p ( x , y ) \vert}^{2}$$
where t^{t} is a refocused image,
$${\underline{h}}_{{z}^{6}}^{NP}$$
is a parametric propagator at the distance z⁶ between the surface of interest (6) and a plane of the sensor (2), like the Lorenz-Mie model, and p(x,y) is the correction function of the aberrations.

2. The method as claimed in claim 1, wherein the calibration objects are spheres with a radius included in a range ranging from 0.01 to 100 μm and with a polydispersity of less than 50% as a coefficient of variation, preferably less than 25%, even more preferably less than 10%, with the refractive index of the calibration objects being advantageously known with an uncertainty of ±2%.

3. The method as claimed in claim 1, wherein the digital model for reconstructing the focused image uses a propagator modified by the aberration correction function.

4. The method as claimed in claim 1, wherein the aberration correction function is a function according to the relationships:
$${F}_{{K}_{x} , {K}_{y}} ( p ( x , y ) ) = p ( {K}_{x} , {K}_{y} , α ) = {e}^{i ( {\sum }_{i} {α}_{i} \times {b}_{i} ( {K}_{x} , {K}_{y} ) )}$$
where F_{K}_{ₓ}_{,K}_{_{y}} is the Fourier transform, Kₓ and K_{y} are the frequency coordinates in the Fourier domain, b={bᵢ(Kₓ,K_{y})}, are the elements of the frequency base and α={αᵢ}ᵢ are the coordinates of the function F_{K}_{ₓ}_{,K}_{_{y}}(p(x,y)) in the base b.

5. The method as claimed in claim 4, wherein, when quantifying the aberrations, the coordinates {αᵢ}ᵢ are computed together with a vector of the parameters of the calibration objects taken into account by the parametric propagator.

6. The method as claimed in claim 4, wherein the base is a Zernike polynomials base.

7. The method as claimed in claim 6, wherein the Zernike polynomials base is limited to the first 15 Zernike polynomials.

8. The method as claimed in claim 1, comprising a preliminary step of locating and approximately characterizing calibration objects using an uncorrected model of the aberrations.

9. The method as claimed in claim 1, wherein quantifying the aberrations is carried out on multiple positions of the defocused holographic image.

10. The method as claimed in claim 1, wherein the defocused holographic image is divided into a plurality of patches and wherein the sample is prepared so as to have at least one calibration object per patch, preferably at least 3 calibration objects per patch.

11. The method as claimed in claim 10, wherein a reconstruction model is implemented per patch, with said model incorporating the quantified aberrations for this patch.

12. The method as claimed in claim 1, wherein the reconstruction is carried out by means of a regularized approach using a non-parametric propagation model, notably a Rayleigh-Sommerfeld model.

13. The method as claimed in claim 1, wherein the correction of the optical aberrations is carried out for multiple wavelengths.

14. The method as claimed in claim 13, wherein a model of optical aberrations is computed for each wavelength of the plurality of wavelengths by imposing a constraint on the location and/or geometric parameters of the calibration objects.

15. The method as claimed in claim 13, wherein a model for reconstructing the digital image integrating the chromatic aberrations is computed for each wavelength of the plurality of wavelengths by imposing a constraint on the object location parameters, common to the entire plurality of wavelengths.

16. A system for characterizing microorganisms present in a biological sample comprising:
a device for acquiring a defocused digital holographic image by means of a microscopic imaging acquisition device with a coherent or partially coherent light source, said device being configured to form interference patterns on a matrix image sensor between the light source and the light diffracted by the microorganisms;
a computing unit configured to:
c. computer generate a focused image by applying a digital model for reconstructing a focused image to the defocused digital holographic image;
d. characterize bacteria as a function of the focused image,
characterized in that:
a.1. acquiring the defocused digital holographic image includes providing, in the field of view of the acquisition device corresponding to said image, a plurality of calibration objects distinct from the microorganisms present in the biological sample, said objects
being previously characterized in terms of size and in terms of refractive index;
having dimensions that are selected so as to produce interference patterns on the matrix image sensor;
having a shape that is selected such that said interference patterns can be computed using a wavefront propagation model integrating optical aberrations of the acquisition device;
b. before computer generating the focused image, the method comprises:
identifying calibration objects in the defocused digital holographic image;
computing the interference patterns of the calibration objects by applying the wavefront propagation model, and quantifying the optical aberrations of the acquisition device as a function of the interference patterns of the calibration objects in the defocused holographic image and the computed interference patterns;
c.1. the digital model for reconstructing the focused image integrates the quantified optical aberrations,
wherein the computation of the aberrations is carried out computationally using a reverse parametric approach using the resolution of a problem according to the following relationships in order to obtain an aberration correction function p(x,y):
$$\underline{{t}^{t}} = arg {min}_{\underline{t}} {‖ d - {m}^{NP} ( \underline{t} ) ‖}_{2}^{2}$$
$${m}^{NP} ( \underline{t} ) = {\vert \underline{t} * {\underline{h}}_{{z}^{6}}^{NP} * p ( x , y ) \vert}^{2}$$
where t^{t} is a refocused image,
$${\underline{h}}_{{z}^{6}}^{NP}$$
is a parametric propagator at the distance z⁶ between the surface of interest (6) and the plane of the sensor (2), like the Lorenz-Mie model, and p(x,y) is the correction function of the aberrations.

17. The system as claimed in claim 13, wherein the computing unit is configured to implement a method as claimed in claim 2.

18. A computer program product comprising a computer memory storing computer-readable instructions for implementing steps c) and d) of a method as claimed in claim 1.
